(19) United States
(12) Patent Application Publication
(10) Pub. No.: US 2015/0200452 A1
(43) Pub. Date: Jul. 16, 2015

(54) PLANAR BEAM STEERABLE LENS ANTENNA SYSTEM USING NON-UNIFORM FEED ARRAY

(71) Applicant: Samsung Electronics Co., Ltd., Suwon-si (KR)

(72) Inventors: Jungsuek Oh, Fairview, TX (US); George Hutcheson, Richardson, TX (US); Farshid Aryanfar, Allen, TX (US)

(21) Appl. No.: 14/590,654

(22) Filed: Jan. 6, 2015

Related U.S. Application Data
(60) Provisional application No. 61/925,987, filed on Jan. 10, 2014.

(51) Int. Cl. H01Q 3/24

(52) U.S. Cl. CPC H01Q 3/245

(57) ABSTRACT

A transmitter or transceiver in a wireless communications device or wireless communications system includes a planar lens antenna system. The planar lens antenna system includes a planar lens comprising a plurality of layers of conductive elements and a substrate layer. The planar lens antenna system also includes an antenna array. The antenna array includes a plurality of non-uniformly spaced feed elements. A first spacing (S1) between a first patch element and a second patch element adjacent to the first patch element is not equal to a second spacing (S2) between the second patch element and a third patch element adjacent to the second patch element.

### CROSS-REFERENCE TO RELATED APPLICATION(S) AND CLAIM OF PRIORITY

The present application claims priority to U.S. Provisional Patent Application Ser. No. 61/925,987, filed Jan. 10, 2014, entitled “PLANAR BEAM STEERABLE LENS ANTENNA SYSTEM USING NON-UNIFORM FEED ARRAY”. The content of the above-identified patent document is incorporated herein by reference.

### TECHNICAL FIELD

The present application relates generally to wireless communications and, more specifically, to a planar antenna system for use in a wireless communications transmitter for enhancing beam patterns at steered angles formed by the planar lens antenna system.

### BACKGROUND

A lens is an electronic device that can focus a planar wave front of EM waves to a focal point or, conversely, collimate spherical waves emitting from a point source to plane waves. Such fundamental characteristics are widely used in various applications, such as communication, imaging, radar, and spatial power combining systems. For example, in millimeter-wave frequency bands that fifth generation (5G) communication standards may employ, lenses have been paid considerable attention as a potential solution to overcome limits in gain and beam steering capabilities of antennas operating in such frequency bands.

### SUMMARY

Embodiments of this disclosure provide a planar antenna system for use in a wireless communications transmitter for enhancing beam patterns at steered angles formed by the planar lens antenna system and methods for enhancing beam patterns at steered angles formed by the planar lens antenna system.

In one embodiment, an apparatus is provided. The apparatus includes a planar lens comprising a plurality of layers of conductive elements and a substrate layer. The apparatus also includes an antenna array. The antenna array includes a plurality of non-uniformly spaced feed elements. A first spacing (S1) between a first patch element and a second patch element adjacent to the first patch element is not equal to a second spacing (S2) between the second patch element and a third patch element adjacent to the second patch element.

In another embodiment, a method is provided. The method includes transmitting electromagnetic waves through a planar lens antenna system. The planar lens antenna system includes a planar lens and an antenna array comprising a plurality of non-uniformly spaced feed elements. A first spacing (S1) between a first patch element and a second patch element adjacent to the first patch element is not equal to a second spacing (S2) between the second patch element and a third patch element adjacent to the second patch element.

In yet another embodiment, a system is provided. The system includes a planar lens antenna system and a transmitter or transceiver. The planar lens antenna system includes a planar lens comprising a plurality of layers of conductive elements and a substrate layer. The planar lens antenna system also includes an antenna array. The antenna array includes a plurality of non-uniformly spaced feed elements. A first spacing (S1) between a first patch element and a second patch element adjacent to the first patch element is not equal to a second spacing (S2) between the second patch element and a third patch element adjacent to the second patch element. The transmitter or transceiver is configured to generate signals for wireless transmission or receive signals transmitted wirelessly via the planar lens antenna system.

Before undertaking the DETAILED DESCRIPTION below, it may be advantageous to set forth definitions of certain words and phrases used throughout this patent document: the turns “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless system in accordance with this disclosure;

FIG. 2 illustrates an example evolved Node B (eNB) according to this disclosure;

FIG. 3 illustrates an example user equipment (UE) according to this disclosure;

FIG. 4A illustrates a dielectric convex lens according to this disclosure;

FIG. 4B illustrates a planar convex lens fed by a planar array according to this disclosure;

FIGS. 5A and 5B illustrate a ray tracing for a polyethylene elliptical lens with spherical air cavity according to this disclosure;

FIG. 6A illustrates a Lens, Antenna-Filter-Antenna (AFA), array structure according to this disclosure;

FIG. 6B illustrates respective layers of an AFA element according to this disclosure;

FIG. 6C illustrates a middle layer of the AFA element of FIG. 6B;

FIG. 6D illustrates a map of the state of the AFA elements in an adaptive lens for different positions of an output beam according to this disclosure;

FIG. 7 illustrates a geometry of a planar lens fed by a patch array according to embodiments of the present disclosure;

FIG. 8 illustrates snapshots of the z-directed total electric field distribution for a 5-GHz line source located at (xₛ, 0): (a) xₛ=0, (b) xₛ=0.05 m, (c) xₛ=0.1 m, (d) xₛ=0.15 m of the planar lens 700 shown in FIG. 7;

FIG. 9 illustrates a top view of planar lens consisting of the subwavelength spatial filters where a small patch indicates a subwavelength unit cell according to this disclosure;

FIG. 10 illustrates a planar lens antenna system according to this disclosure;

FIG. 11 shows radiation patterns of planar lens antenna system when single patch element is switched ‘on’ in order according to this disclosure;

FIG. 12 illustrates a planar lens antenna system according to this disclosure;

FIG. 13 illustrates another planar lens antenna system according to this disclosure;

FIG. 14 shows radiation patterns of planar lens antenna system when single patch element or subarray grouped by two or more patch elements is switched ‘on’ in order according to this disclosure;

FIG. 15 shows radiation patterns of planar lens antenna system when fed by single patch (‘4’ at bore sight) feed (dash line) and one case of NON-uniformly spaced 1×7 patch array using 2 bit phase shifters (solid line) according to this disclosure;

FIG. 16 shows radiation patterns of planar lens antenna system with non-uniformly spaced feed elements achieving the same level of the gain as use of a single feed element at bore-sight according to this disclosure;

FIG. 17 illustrates a patch antenna array with non-uniformly grouped switched subarray according to this disclosure;

FIG. 18 illustrates a patch antenna array with non-uniformly grouped switched subarray according to this disclosure;

FIG. 19 illustrates an example of a patch antenna array with uniformly spaced patch elements according to this disclosure; and

FIG. 20 illustrates a patch antenna array with non-uniformly spaced patch elements according to this disclosure.

### DETAILED DESCRIPTION

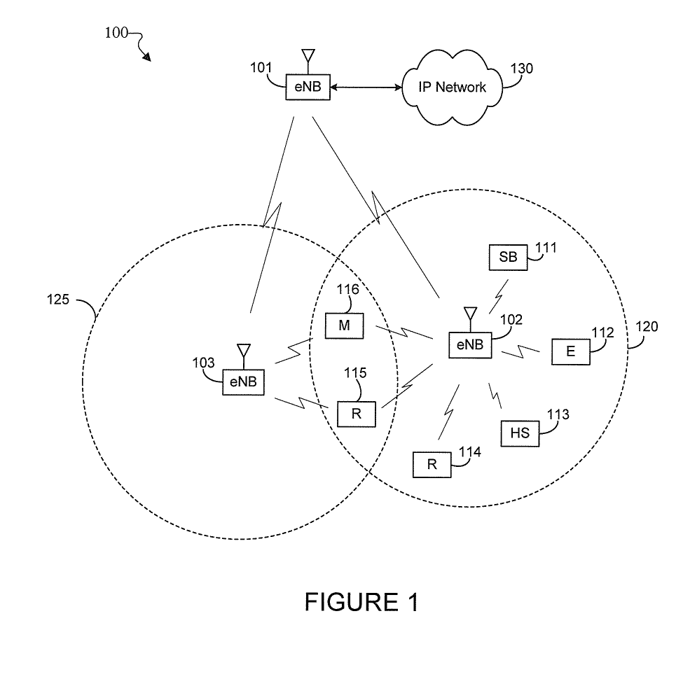

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

The following documents and standards descriptions are hereby incorporated into the present disclosure: J. R. Costa, E. B. Lima, and C. A. Fernandes, “Compact beam-steerable lens antenna for 60-GHz wireless communications,” IEEE Trans. Antennas Propagat., vol. 57, no. 10, pp. 2926-2933, October 2009 (REF 1); C.-C. Cheng and A. Abbaspour-Tamijani, “Study of 2-bit antenna-filter-antenna elements for reconfigurable millimeter-wave lens arrays,” IEEE Trans. Microw. Theory Tech., vol. 54, no. 12, pp. 4498-4506, 2006 (REF 2); C.-C. Cheng, B. Lakshminarayanan, and A. Abbaspour-Tamijani, “A programmable lens-array antenna with monolithically integrated MEMS switches,” IEEE Trans. Microwaves Theory Tech., vol. 57, no. 8, pp. 1874-1884, August 2009 (REF 3); D. H. Kwon and D. H. Werner, “Beam scanning using flat transformation electromagnetic focusing lenses,” IEEE Antennas Wireless Propag. Lett., vol. 8, pp. 1115-1118, 2009 (REF 4); A. Abbaspour-Tamijani, L. Zhang and H. K. Pan, “Enhancing the directivity of phased array antennas using lens-arrays,” Progress In Electromagnetics Research M, Vol. 29, 41-64, 2013 (REF 5); J. Oh, G. Hutcheson, and W. Hong, “Low-Cost Low-Loss Planar Lens Employing Mixed-Order Cauer/Elliptic Filter,” Prosecution ID WD-201304-024-1-USO, April 2013 (REF 6); J. Oh and G. Hutcheson, “Single-Substrate Planar Lens Employing Spatial Mixed-Order Bandpass Filter,” Prosecution ID WD-201307-013-1-USO, July 2013; and U.S. patent application Ser. No. 14/293,985 filed on Jun. 2, 2014 and entitled “Lens WITH SPATIAL MIXED-ORDER BANDPASS FILTER” (REF 7). The contents of which are hereby incorporated by reference in their entirety.

Various figures described below may be implemented in wireless communication systems, possibly including those that use orthogonal frequency division multiplexing (OFDM) or orthogonal frequency division multiple access (OFDMA) communication techniques. However, the descriptions of these figures are not meant to imply physical or architectural limitations in the manner in which different embodiments may be implemented. Different embodiments of this disclosure may be implemented in any suitably-arranged communication systems using any suitable communication techniques.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, one or more of eNBs 101-103 include a transmitter having a planar lens antenna system configured to enhance beam patterns at steered angles formed by planar lens antenna systems where both lens and feed network have planar configuration. Additionally, one or more of UEs 111-116 include a transmitter having a planar lens antenna system configured to enhance beam patterns at steered angles formed by planar lens antenna systems where both lens and feed network have planar configuration.

Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

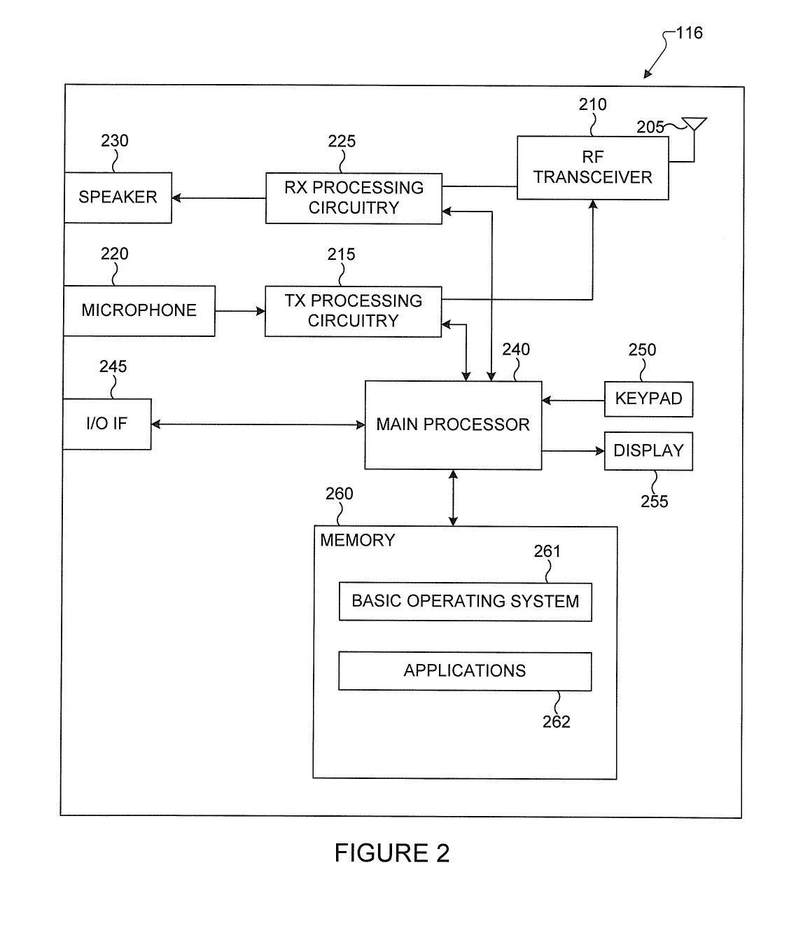

FIG. 2 illustrates an example UE 116 according to this disclosure. The embodiment of the UE 116 illustrated in FIG. 2 is for illustration only, and the UEs 111-115 of FIG. 1 could have the same or similar configuration. However, UEs come in a wide variety of configurations, and FIG. 2 does not limit the scope of this disclosure to any particular implementation of a UE.

The UE 116 includes an antenna 205, a radio frequency (RF) transceiver 210, transmit (TX) processing circuitry 215, a microphone 220, and receive (RX) processing circuitry 225. The UE 116 also includes a speaker 230, a main processor 240, an input/output (I/O) interface (IF) 245, a keypad 250, a display 255, and a memory 260. The memory 260 includes a basic operating system (OS) program 261 and one or more applications 262.

The antenna 205 is configured as a planar lens antenna configured to enhance beam patterns at steered angles formed by the antenna 205 where both lens and feed network have planar configuration. The antenna 205 includes a planar lens, such as described in REF 7, and one or more antenna elements.

The RF transceiver 210 receives, from the antenna 205, an incoming RF signal transmitted by an eNB of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the main processor 240 for further processing (such as for web browsing data).

The TX processing circuitry 215 receives analog or digital voice data from the microphone 220 or other outgoing baseband data (such as web data, e-mail, or interactive video game data) from the main processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna 205.

The main processor 240 can include one or more processors or other processing devices and execute the basic OS program 261 stored in the memory 260 in order to control the overall operation of the UE 116. For example, the main processor 240 could control the reception of forward channel signals and the transmission of reverse channel signals by the RF transceiver 210, the RX processing circuitry 225, and the TX processing circuitry 215 in accordance with well-known principles. In some embodiments, the main processor 240 includes at least one microprocessor or microcontroller.

The main processor 240 is also capable of executing other processes and programs resident in the memory 260, such as operations for beam steering via antenna 205. The main processor 240 can move data into or out of the memory 260 as required by an executing process. In some embodiments, the main processor 240 is configured to execute the applications 262 based on the OS program 261 or in response to signals received from eNBs or an operator. The main processor 240 is also coupled to the I/O interface 245, which provides the UE 116 with the ability to connect to other devices such as laptop computers and handheld computers. The I/O interface 245 is the communication path between these accessories and the main controller 240.

The main processor 240 is also coupled to the keypad 250 and the display unit 255. The operator of the UE 116 can use the keypad 250 to enter data into the UE 116. The display 255 may be a liquid crystal display or other display capable of rendering text and/or at least limited graphics, such as from web sites.

The memory 260 is coupled to the main processor 240. Part of the memory 260 could include a random access memory (RAM), and another part of the memory 260 could include a Flash memory or other read-only memory (ROM).

Although FIG. 2 illustrates one example of UE 116, various changes may be made to FIG. 2. For example, various components in FIG. 2 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 2 illustrates the UE 116 configured as a mobile telephone or smartphone, UEs could be configured to operate as other types of mobile or stationary devices.

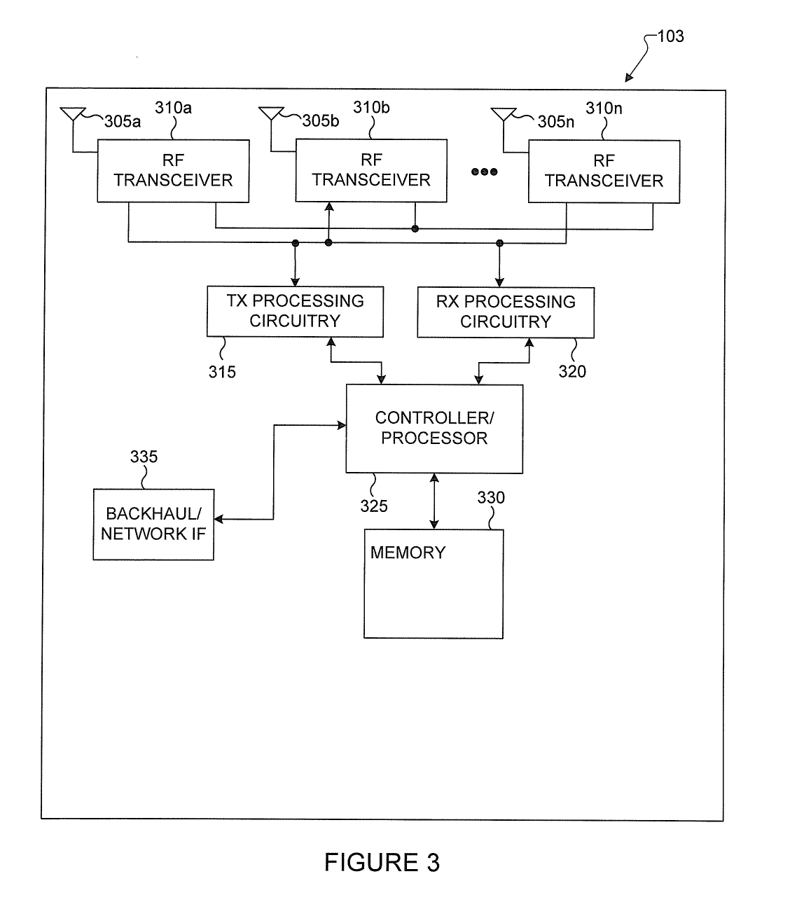

FIG. 3 illustrates an example eNB 102 according to this disclosure. The embodiment of the eNB 102 shown in FIG. 3 is for illustration only, and other eNBs of FIG. 1 could have the same or similar configuration. However, eNBs come in a wide variety of configurations, and FIG. 3 does not limit the scope of this disclosure to any particular implementation of an eNB.

As shown in FIG. 3, the eNB 102 includes multiple antennas 305a-305n, multiple RF transceivers 310a-310n, transmit (TX) processing circuitry 315, and receive (RX) processing circuitry 320. The eNB 102 also includes a controller/processor 325, a memory 330, and a backhaul or network interface 335.

The antennas 305a-305n are configured as a planar lens antennas configured to enhance beam patterns at steered angles formed by the antennas 305a-305n where both lens and feed network have planar configuration. Each of the antennas 305a-305n includes a planar lens, such as described in REF 7, and one or more antenna elements.

The RF transceivers 310a-310n receive, from the antennas 305a-305n, incoming RF signals, such as signals transmitted by UEs or other eNBs. The RF transceivers 310a-310n down-convert the incoming RF signals to generate IF or baseband signals. The IF or baseband signals are sent to the RX processing circuitry 320, which generates processed baseband signals by filtering, decoding, and/or digitizing the baseband or IF signals. The RX processing circuitry 320 transmits the processed baseband signals to the controller/processor 325 for further processing.

The TX processing circuitry 315 receives analog or digital data (such as voice data, web data, e-mail, or interactive video game data) from the controller/processor 325. The TX processing circuitry 315 encodes, multiplexes, and/or digitizes the outgoing baseband data to generate processed baseband or IF signals. The RF transceivers 310a-310n receive the outgoing processed baseband or IF signals from the TX processing circuitry 315 and up-converts the baseband or IF signals to RF signals that are transmitted via the antennas 305a-305n.

The controller/processor 325 can include one or more processors or other processing devices that control the overall operation of the eNB 102. For example, the controller/processor 325 could control the reception of forward channel signals and the transmission of reverse channel signals by the RF transceivers 310a-310n, the RX processing circuitry 320, and the TX processing circuitry 315 in accordance with well-known principles. The controller/processor 325 could support additional functions as well, such as more advanced wireless communication functions. For instance, the controller/processor 325 could support beam forming or directional routing operations in which outgoing signals from multiple antennas 305a-305n are weighted differently to effectively steer the outgoing signals in a desired direction. Any of a wide variety of other functions could be supported in the eNB 102 by the controller/processor 325. In some embodiments, the controller/processor 325 includes at least one microprocessor or microcontroller.

The controller/processor 325 is also capable of executing programs and other processes resident in the memory 330, such as a basic OS. The controller/processor 325 can move data into or out of the memory 330 as required by an executing process.

The controller/processor 325 is also coupled to the backhaul or network interface 335. The backhaul or network interface 335 allows the eNB 102 to communicate with other devices or systems over a backhaul connection or over a network. The interface 335 could support communications over any suitable wired or wireless connection(s). For example, when the eNB 102 is implemented as part of a cellular communication system (such as one supporting 5G, LTE, or LTE-A), the interface 335 could allow the eNB 102 to communicate with other eNBs over a wired or wireless backhaul connection. When the eNB 102 is implemented as an access point, the interface 335 could allow the eNB 102 to communicate over a wired or wireless local area network or over a wired or wireless connection to a larger network (such as the Internet). The interface 335 includes any suitable structure supporting communications over a wired or wireless connection, such as an Ethernet or RF transceiver.

The memory 330 is coupled to the controller/processor 325. Part of the memory 330 could include a RAM, and another part of the memory 330 could include a Flash memory or other ROM.

As described in more detail below, the transmit and receive paths of the eNB 102 (implemented using the RF transceivers 310a-310n, TX processing circuitry 315, and/or RX processing circuitry 320) support communication with aggregation of FDD cells and TDD cells.

Although FIG. 3 illustrates one example of an eNB 102, various changes may be made to FIG. 3. For example, the eNB 102 could include any number of each component shown in FIG. 3. As a particular example, an access point could include a number of interfaces 335, and the controller/processor 325 could support routing functions to route data between different network addresses. As another particular example, while shown as including a single instance of TX processing circuitry 315 and a single instance of RX processing circuitry 320, the eNB 102 could include multiple instances of each (such as one per RF transceiver).

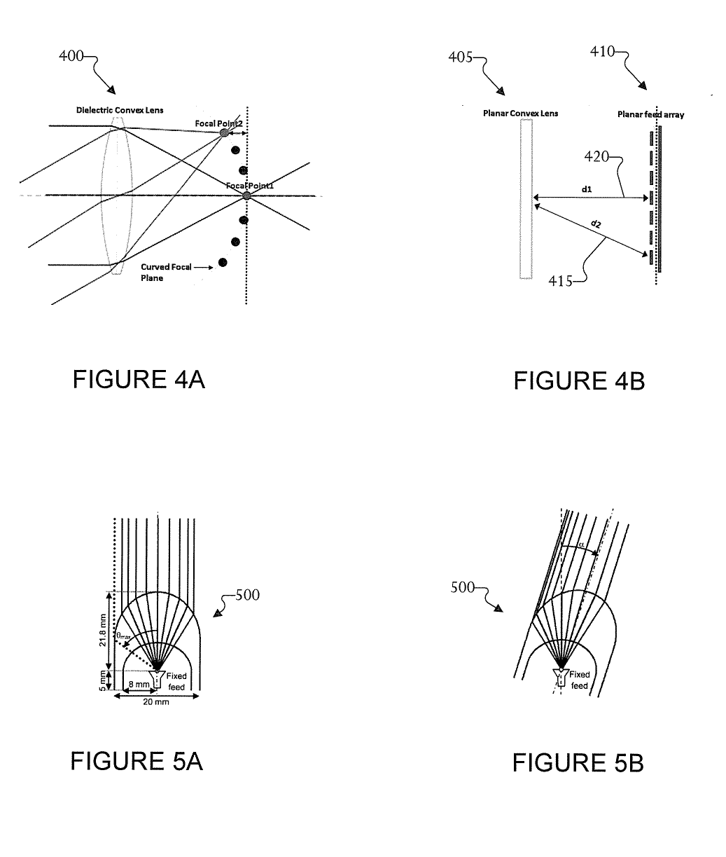

FIG. 4A illustrates a dielectric convex lens according to this disclosure. FIG. 4B illustrates a planar convex lens fed by a planar array according to this disclosure. The embodiments of the dielectric convex lens 400 and the planar convex lens 405 fed by the planar array 410 are for illustration only. Other embodiments could be used without departing from the scope of the present disclosure.

In certain beam-steering lens antenna systems, flat configurations, such as the planar convex lens 405 fed by the planar array 410, of the lens antenna system are utilized as opposed to a conventional lens antenna system having curved shape, such as the dielectric convex lens 400, pursuing a practical usage of the lens antenna system. However, the flat configurations force inherently curved focal (feed) plane of the lens to be flat, which causes a decrease in gain or beam steering capability of the entire lens antenna system.

FIGS. 5A and 5B illustrate a ray tracing for a polyethylene elliptical lens with spherical air cavity according to this disclosure. The embodiments of the elliptical lens 500 are for illustration only. Other embodiments could be used without departing from the scope of the present disclosure.

In certain systems, to achieve beam steering capability for lens antenna system, the entire lens was rotated while feed antenna is fixed as shown FIGS. 5A and 5B. For example, in the example shown in FIG. 5A, the elliptical lens 500 is in a zero-tilt case while in the example shown in FIG. 5B, the elliptical lens 500 is at a 15° lens-tilt. However, the elliptical lens 500 has a very bulky size and heavy weight due to a mechanically controlled module necessary to rotate the elliptical lens 500.

To avoid the bulky configuration of the elliptical lens 500, certain lens systems incorporate a flat surface. This type of lens is composed of numerous flat unit cells providing a required level of phase shifts at appropriate locations. For beam steering, two approaches are possible.

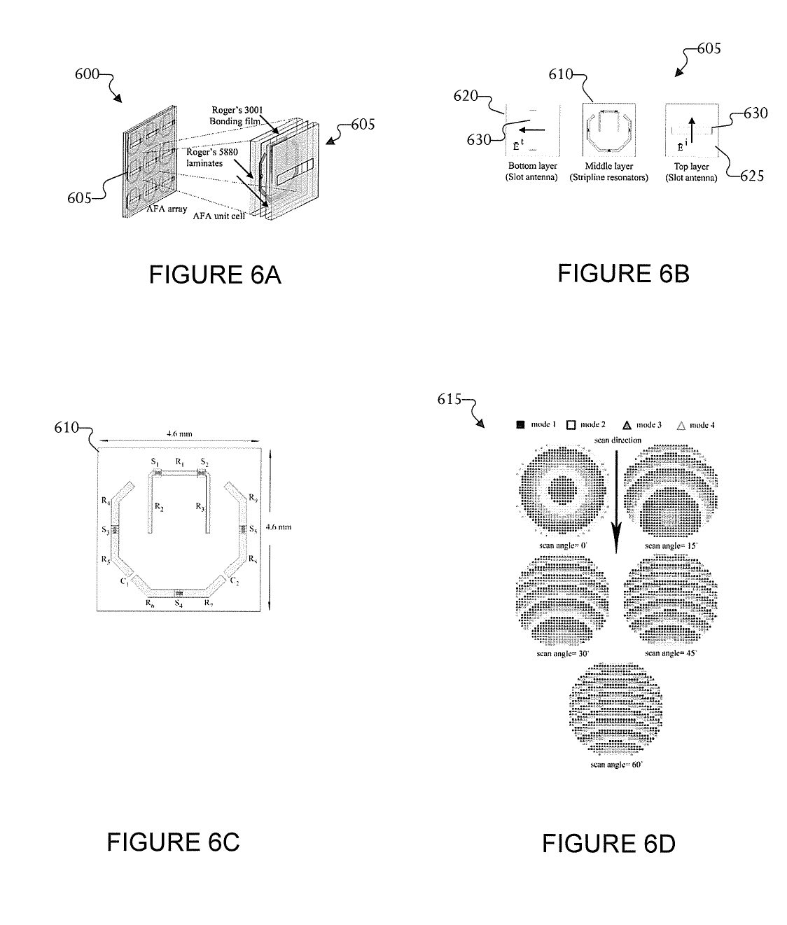

In one approach is to realize reconfigurability for beam steering on lens surface by incorporating switch components inserted into all unit cells. FIG. 6A illustrates a Lens, Antenna-Filter-Antenna (AFA), array structure according to this disclosure. FIG. 6B illustrates respective layers of an AFA element according to this disclosure. FIG. 6C illustrates a middle layer of the AFA element of FIG. 6B. FIG. 6D illustrates a map of the state of the AFA elements in an adaptive lens array for different positions of an output beam according to this disclosure. The embodiments of the Lens array 600, AFA element 605, middle layer 610 and map states 615 shown in FIGS. 6A through 6D are for illustration only. Other embodiments could be used without departing from the scope of the present disclosure.

In the example shown in FIGS. 6A through 6D, the lens array 600 includes switch components inserted into all unit cells. Controlling the switching operation can achieve different levels of phase shift. The lens array 600 includes a number of unit cells 605. Each unit cell 605 includes the middle layer 610 disposed between a bottom layer 620 and a top layer 625. The layers 610, 620 and 625 can be coupled using ROGER's 3001 Bonding film 625. The top layer 625 and bottom layer 620 each include a slot antenna 630 oriented to be perpendicular with respect to each other. The top layer 625 and bottom layer 620 can be comprised of ROGER's 5880 laminates. While this provides ideal beam steering and shaping by fully designing the entire radiating aperture for all the cases of beam steering, a system configuration becomes extremely complicated requiring a massive number of switch components and respective bias modules.

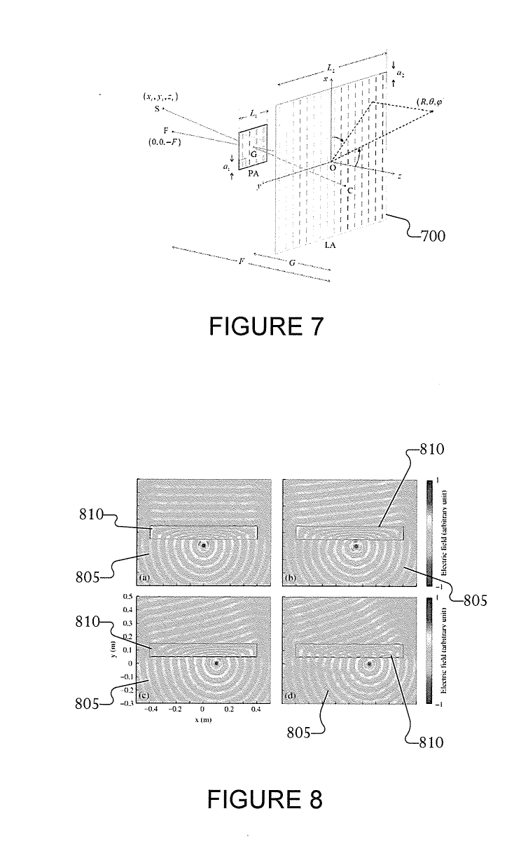

The other approach is to use typical phased patch antennas that excites planar lens at steered angle. FIG. 7 illustrates a geometry of a planar lens fed by a patch array according to embodiments of the present disclosure. The embodiment of the planar lens 700 shown in FIG. 7 is for illustration only. Other embodiments could be used without departing from the scope of the present disclosure.

Exiting a planar lens 700 at a steered angle provides much simpler and cheaper configuration compared to the aforementioned other types of lens antenna systems. However, this planar lens 700 system suffers from poor performance. The performance degradation results from the multiple numbers of feed elements used for beam steering, which violates a fundamental assumption in traditional lens design to use a single focal point, that is, one point source. The performance degradation also results from an increased spill-over loss as a part of the steered beam goes towards an outside of finite-size lens. These drop a gain enhancement factor of the planar lens 700.

FIG. 8 illustrates snapshots of the z-directed total electric field distribution for a 5-GHz line source located at (xₛ, 0): (a) xₛ=0, (b) xₛ=0.05 m, (c) xₛ=0.1 m, (d) xₛ=0.15 m of the planar lens 700 shown in FIG. 7. The embodiments of the electric field distributions shown in FIG. 8 are for illustration only. Other embodiments could be used without departing from the scope of the present disclosure.

In order to avoid simultaneous excitation of multiple feed elements in the aforementioned first reason, use of switch components with the phased array was introduced REF 4. In this approach, only one patch element related to a required beam steering angle is turned on, which provides spherical wave-front 805 shape of one point source considered in original lens design. This beam steering technique stems from the fact that one point, or line, source positioned off the center of the lens can excite steered plane wave after the lens 810. FIG. 8 shows this inherent characteristic of the lens where, when xₛ is not at ‘0 m’, an outgoing plane wave 805 is steered. While this approach comes close to single source assumption of the lens design, the performance of lens antenna system still suffers from high spill-over loss when the patch element near one end of lens is excited for highly steered angle.

Accordingly, various embodiments of antenna systems can be summarized having various drawbacks. A Rotating lens with fixed antenna feed causes too bulky and heavy hardware. Realizing reconfigurability of phase shift on lens surface using numerous switch components causes extremely high hardware complexity and cost. Combining phased array antennas with planar lens provides simplest configuration and low cost. However, disagreement between point source assumptions considered in general lens design and features of phased array antenna causes poor performance.

To overcome the aforementioned deficiencies, embodiments of the present disclosure describe a planar lens antenna system that applies non-uniformness for feed array. Applying non-uniformness for feed array can significantly enhance the performance of planar lens antenna system. According to embodiments of the present disclosure, the advantages of the non-uniformness of feed array are demonstrated in two approaches: 1) Non-Uniformly Grouped Switched Sub-array Feed; and 2) a Non-Uniformly Spaced Feed Array.

In certain embodiments, a planar lens antenna system includes non-uniformly grouped switched subarray feed. For electromagnetic simulation to demonstrate the advantage of this approach, a flat lens is designed using subwavelength spatial filters.

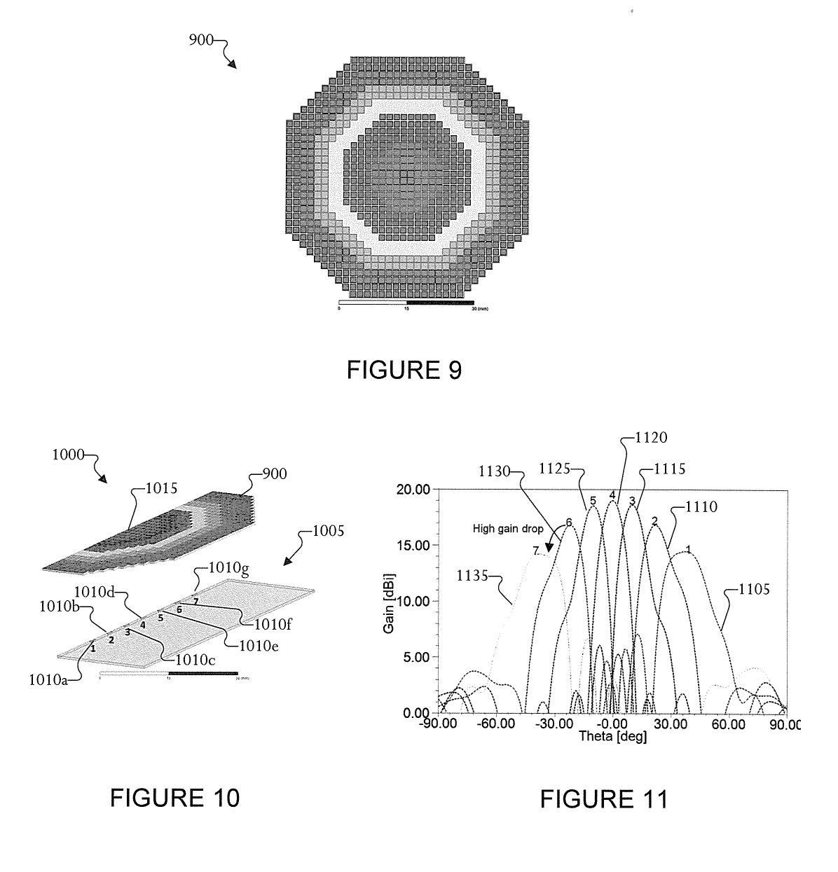

FIG. 9 illustrates a top view of planar lens consisting of the subwavelength spatial filters where a small patch indicates a subwavelength unit cell according to this disclosure. The embodiment of the planar lens 900 shown in FIG. 9 is for illustration only. In certain embodiments, the lens 900 is a planar lens as described in REF 7. Other embodiments could be used without departing from the scope of the present disclosure. The planar lens 900 is designed at 28 GHz and dimensioned to be 50 mm (width1)×50 mm (width2)×0.5 mm (thickness).

FIG. 10 illustrates a planar lens antenna system according to this disclosure. The embodiment of the planar lens antenna system 1000 shown in FIG. 10 is for illustration only. Other embodiments could be used without departing from the scope of the present disclosure.

The planar lens antenna system 1000 includes the planar lens 900 coupled to a 1×7 patch array 1005. The 1×7 patch array 1005 includes seven patch elements 1010a, 1010b, 1010c, 1010d, 1010e, 1010f and 1010g (also referred to as feed elements). FIG. 10 shows oblique perspective of the planar lens 900 fed by the 1×7 patch array 1005 where the distance between patch element ‘4’ 1010d and a center 1015 of the lens is same as focal length of the planar lens. The spacing between patch elements 1010a-1010g are uniform as λ/2. That is, a spacing between a first patch element 1010a and a second patch element 1010b is λ/2, a spacing between the second patch element 1010b and a third patch element 1010c is λ/2; a spacing between the third patch element 1010c and the fourth patch element 1010d is λ/2; a spacing between the fourth patch element 1010d and a fifth patch element 1010e is λ/2; a spacing between the fifth patch element 1010e and a sixth patch element 1010f is λ/2; and a spacing between the sixth patch element 1010f and a seventh patch element 1010g is λ/2. In the example shown in FIG. 10, only half of the planar lens antenna system 1000 is illustrated due to a symmetric boundary condition and for ease of illustration.

FIG. 11 shows radiation patterns of planar lens antenna system when single patch element is switched ‘on’ in order according to this disclosure. The radiation patterns are for illustration only and depict an example for explanation purposes only. Other radiation patterns could be produced and illustrated without departing from the scope of the present disclosure.

In on illustrative example, only one patch antenna feeds the lens by switching the patch elements 1010a-1010g in order. In the example illustrated in FIG. 11, the radiation patterns of planar lens antenna system when single patch element is switched ‘on’ in order as follows: a first radiation pattern 1105 corresponds to when the first patch element 1010a is switched on; a second radiation pattern 1110 corresponds to when the second patch element 1010b is switched on; a third radiation pattern 1115 corresponds to when the third patch element 1010c is switched on; a fourth radiation pattern 1120 corresponds to when the fourth patch element 1010d is switched on; a fifth radiation pattern 1125 corresponds to when the fifth patch element 1010e is switched on; a sixth radiation pattern 1130 corresponds to when the sixth patch element 1010f is switched on; and a seventh radiation pattern 1135 corresponds to when the seventh patch element 1010g is switched on.

The radiation patterns depicted in FIG. 11 a significant drop in gain when switching from the sixth patch element 1010f to the seventh patch element 1010g or switching from the second patch element 1010b to the first patch element 1010a. This significant drop is due to the fact that in flat feed plane the distance between the end feed element 1010 and the lens 900 (that is ‘d2’ 415 shown in FIG. 4B) can be much longer than the distance between the center feed element, namely, the fourth patch element 1010d, and the lens (‘d1’ 420 shown in FIG. 4B). While a gain enhancement factor of using the lens is maximized when peak beam is emitted by a feed points in the center of the lens, the aforementioned difference between ‘d1’ 420 and ‘d2’ 415 causes peak beams emitted by the end feed elements to point in the end of the lens. This mismatch causes a decrease in gain at steered angle.

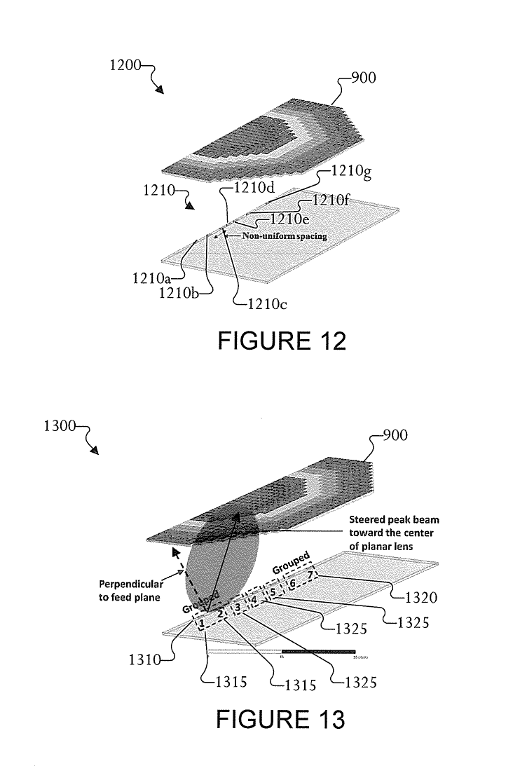

FIG. 12 illustrates a planar lens antenna system 1200 according to this disclosure. The embodiment of the planar lens antenna system 1200 shown in FIG. 12 is for illustration only. Other embodiments could be used without departing from the scope of the present disclosure.

In contrast to the planar lens antenna system 1000 of FIG. 10 in which one lens is excited by uniformly spaced feed array, the planar lens antenna system 1200 is excited by non-uniformly spaced feed array. The planar lens antenna system 1200 includes a planar lens 900 and a non-uniformly spaced feed array 1210 for the planar lens antenna system 1200. The non-uniformly spaced feed array includes a number of patch elements 1210a-g. The patch elements 1210a-g can be the same or similar to the patch elements 1010. In non-uniformly spaced feed array 1210, the spacing between two patch elements varies from λ/4 to λ/2 and 3λ/4 and where the two patch elements near the center of the lens have narrowest spacing (λ/4). For example, a spacing between a first patch element 1210a and a second patch element 1210b can be 3λ/4, a spacing between the second patch element 1210b and a third patch element 1210c is λ/2; a spacing between the third patch element 1210c and the fourth patch element 1210d is λ/4; a spacing between the fourth patch element 1210d and a fifth patch element 1210e is λ/4; a spacing between the fifth patch element 1210e and a sixth patch element 1210f is λ/2; and a spacing between the sixth patch element 1210f and a seventh patch element 1210g is 3λ/4. This non-uniform distribution of patch elements in the feed array 1210 can be understood intuitively based on the fact that a projection of point sources on curved focal plane toward a flat plane renders uniformly spaced distribution of the point sources. For example, suppose that point sources in FIG. 4A are projected on flat plane in FIG. 4B.

FIG. 13 illustrates a planar lens antenna system according to this disclosure. The embodiment of the planar lens antenna system 1300 shown in FIG. 13 is for illustration only. Other embodiments could be used without departing from the scope of the present disclosure

The planar lens antenna system 1300 includes a planar lens 900 and a non-uniformly spaced feed array 1310 for the planar lens antenna system 1300. In the example shown in FIG. 13, an oblique perspective of planar lens 900 fed by non-uniformly grouped patch array 1310 is shown for ease of illustration. In certain embodiments, one or more patch elements are replaced with sub-group patch elements 1310. Each sub-group patch element 1310 can include one or more patch elements 1315. The patch elements 1315 can be the same or similar to the patch elements 1010 or patch elements 1210. In certain embodiments, a first spacing between a first feed connected to a first sub-group 1310 and a second feed connected to a second sub-group 1325 adjacent to the first feed is equal to a second spacing between the second feed and a third feed connected to a third sub-group 1320 adjacent to the second feed. In certain embodiments, a first spacing between a first feed connected to a first sub-group 1310 and a second feed connected to a second sub-group 1325 adjacent to the first feed is not equal to a second spacing between the second feed and a third feed connected to a third sub-group 1320 adjacent to the second feed. In certain embodiments, each sub-group patch element 1310 includes the same number of patch elements 1315 as the other sub-group patch elements 1310. In certain embodiments, each sub-group patch element 1310 includes a different number of patch elements 1315 than the other sub-group patch elements 1310. In certain embodiments, the non-uniformly spaced feed array 1310 includes individual patch elements 1315 and one or more sub-group patch elements 1310. For example, the non-uniformly spaced feed array 1310 can include a first sub-group patch element 1310, a second group patch element 1320 and a number of individual patch elements 1325. The individual patch elements 1325 can be the same as the individual patch elements 1315 in the sub-group patch element 1310 with the exception that the individual patch elements 1325 receive signals from different respective feed sources. In certain embodiments, the non-uniformly spaced feed array 1310 includes only sub-group patch elements 1310.

In certain embodiments, the planar lens antenna system 1300 includes a switched feed element close to the end of the lens with larger number of patch elements that are employed as a subarray feed. That is, the patch elements 1315 in the sub-group element 1310 are coupled to receive a signal from the same feed source. Collectively using of larger number of patch elements near the end of the lens enables steering the peak beam toward the center of the planar lens 900 and, thus, increases effective gain enhancement factor that can be acquired by using the planar lens 900.

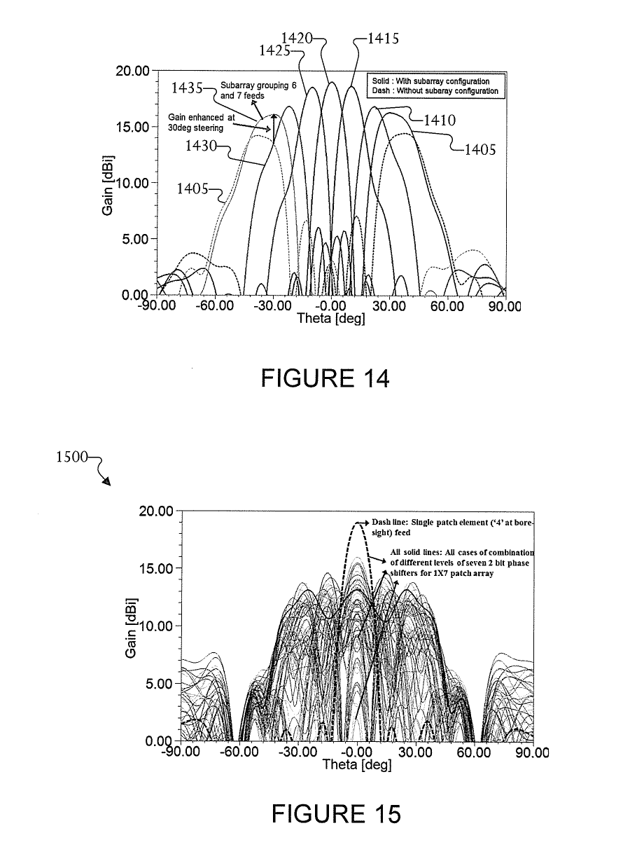

FIG. 14 shows radiation patterns of planar lens antenna system when single patch element or subarray grouped by two or more patch elements is switched ‘on’ in order according to this disclosure. The radiation patterns are for illustration only and depict an example for explanation purposes only. Other radiation patterns could be produced and illustrated without departing from the scope of the present disclosure.

In the example illustrated in FIG. 14, the radiation patterns of planar lens antenna system when single patch element or subarray grouped by two or more patch elements is switched ‘on’ in order as follows: a first radiation pattern 1405 corresponds to when the second sub-group patch element 1320 is switched on, the second sub-group patch element 1320 comprising the first and second patch elements 1315; a second radiation pattern 1410 corresponds to when only the second patch element 1315 is switched on; a third radiation pattern 1415 corresponds to when the third patch element 1315 is switched on; a fourth radiation pattern 1420 corresponds to when the fourth patch element 1315 is switched on; a fifth radiation pattern 1425 corresponds to when the fifth patch element 1315 is switched on; a sixth radiation pattern 1430 corresponds to when the sixth patch element 1315 is switched on; and a seventh radiation pattern 1435 corresponds to when the first sub-group patch element 1310 is switched on, the first sub-group patch element 1310 comprising the sixth and seventh patch elements 1315. This demonstrates that using uniformly-grouped subarray feed can provide more than 3 dB gain enhancement at 30° steered angle.

FIG. 15 shows radiation patterns of planar lens antenna system when fed by single patch (‘4’ at bore sight) feed (dash line) and one case of NON-uniformly spaced 1×7 patch array using 2 bit phase shifters (solid line) according to this disclosure. The radiation patterns 1500 are for illustration only and depict an example for explanation purposes only. Other radiation patterns could be produced and illustrated without departing from the scope of the present disclosure. In the Radiation patterns depicted in FIG. 15, phase distribution of non-uniformly spaced 7 feed elements is: 90°, 0°, 90°, 0°, 0°, 0°, 90°, 0° and 90°.

Embodiments of the present disclosure illustrate an example exhibiting the benefit of using the non-uniformly spaced feed array. Unlike the previous section employing switching method and in order to show diverse application areas employing the non-uniformness for lens feed array it is assumed that all patch elements in FIG. 12 are turned on and magnitudes of delivered power toward all the patch elements are same but only their phase is controlled for beam steering. For further practical case, the levels of phase of the feeds are limited as four steps provided by 2-bit phase shifter (0°, 90°, 180° and 270°). FIG. 15 provides an illustration of a practical problem addressed by embodiments of the present disclosure. The radiation patterns of planar lens 900 when fed by single patch (‘4’ at bore sight) feed and all cases of uniformly spaced (λ/4, λ/2 and 3λ/4) 1×7 patch array using 2 bit phase shifters. It is found that combination of all possible levels of seven 2-bit phase shifters feeding 1×7 patch elements can never achieve the same level of gain value acquired by a single feed element pointing in the center of the lens. In other words, without the switching method, the planar lens antenna system excited by equi-magnitude and 2-bit phase shift feed array suffers from significant degradation in bore-sight gain. However, a non-uniformly spaced feed array of the invention can easily complete the gain degradation.

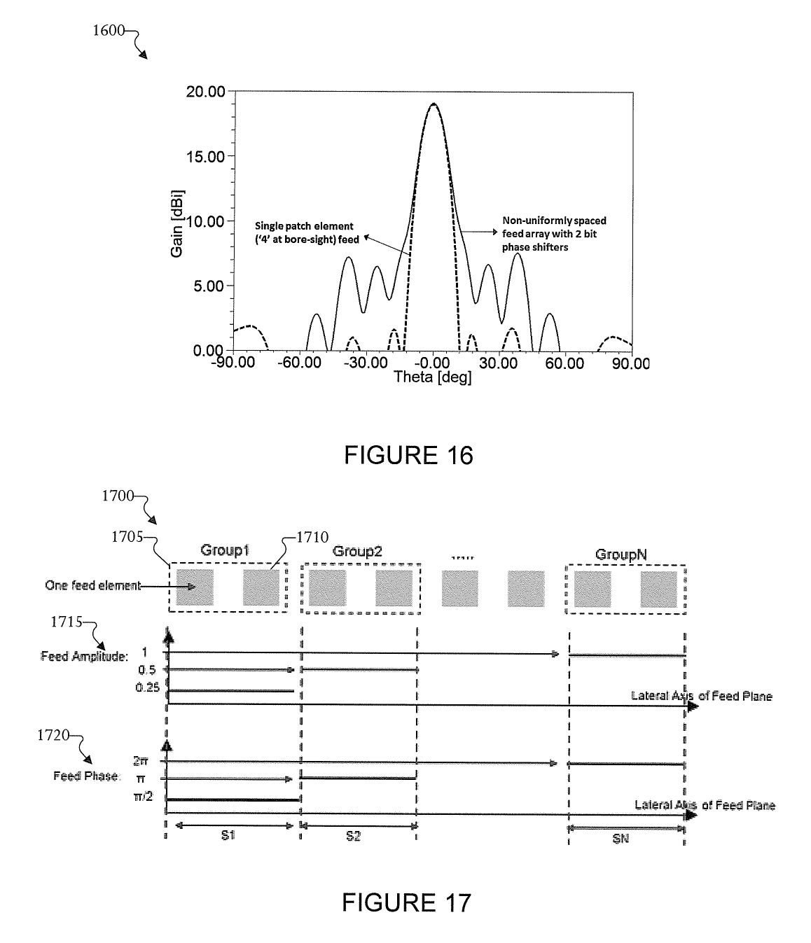

FIG. 16 shows radiation patterns of planar lens antenna system with non-uniformly spaced feed elements achieving the same level of the gain as use of a single feed element at bore-sight according to this disclosure. The radiation patterns 1600 are for illustration only and depict an example for explanation purposes only. Other radiation patterns could be produced and illustrated without departing from the scope of the present disclosure. This embodiment eliminates the need to increase the number of steps of phase shift related to complicated and expensive hardware configuration.

Embodiments of the present disclosure provide methods for applying non-uniformness for feed array of planar lens antenna system. For example, a first method includes non-uniformly grouped switched subarray feed that enhances gain of planar lens antenna system at highly beam-steered angle. A second method includes a non-uniformly spaced feed array enhances bore-sight gain of planar lens antenna system fed by low-bit phase shifters. This lowers cost and complexity in feed network for planar lens antenna system.

Embodiments of the present disclosure provide methods for applying non-uniformness for feed array of planar lens antenna system. For example, a first method includes non-uniformly grouped switched subarray feed that enhances gain of planar lens antenna system at highly beam-steered angle. A second method includes a non-uniformly spaced feed array enhances bore-sight gain of planar lens antenna system fed by low-bit phase shifters. This lowers cost and complexity in feed network for planar lens antenna system.

FIG. 17 illustrates a patch antenna array with non-uniformly grouped switched subarray according to this disclosure. The embodiment of the patch antenna 1700 shown in FIG. 17 is for illustration only. Other embodiments could be used without departing from the scope of the present disclosure.

The patch antenna 1700 includes a non-uniformly grouped switched subarray feed that enhances gain of the planar lens antenna system at highly beam-steered angle. The patch antenna 1700 includes a number of sub-groups 1705, each sub-group having a fixed number of feed elements 1710, such as fixed as two. The geometry of a feed element is a fixed as Square Shape. The excitation amplitude 1715 or phase 1720, or both, of each group of feed element relative to the other groups is the same to be S1=S2= . . . =SN.

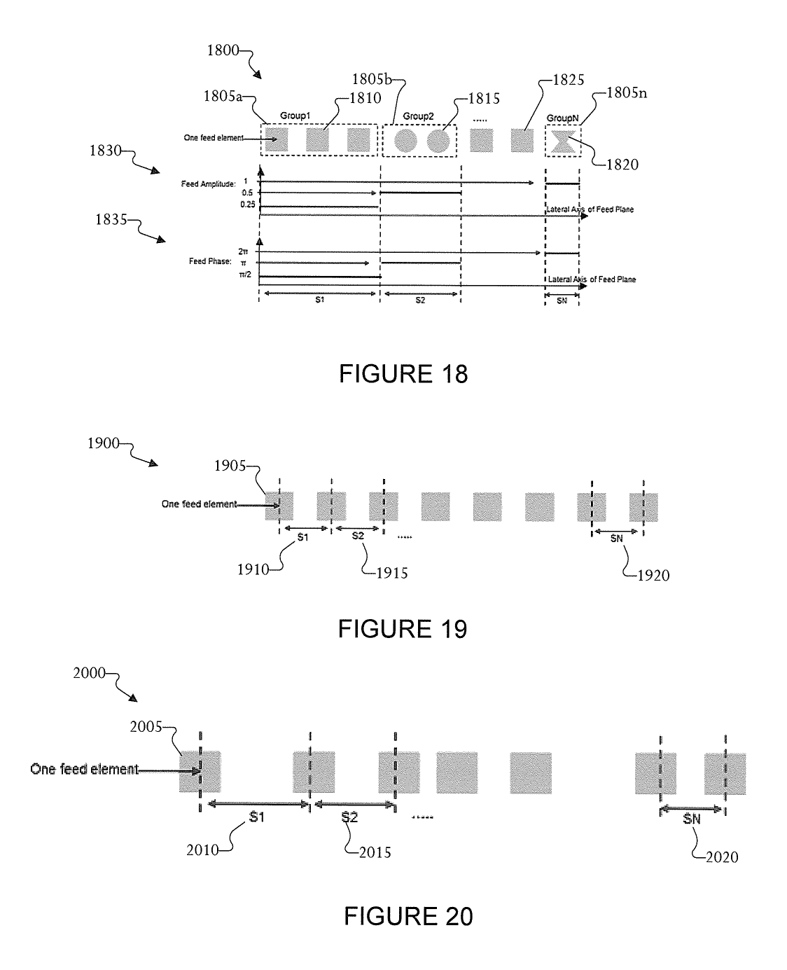

FIG. 18 illustrates a patch antenna array with non-uniformly grouped switched array according to this disclosure. The embodiment of the patch antenna 1800 shown in FIG. 18 is for illustration only. Other embodiments could be used without departing from the scope of the present disclosure.

In certain embodiments, each group can have different configurations in terms of the number of feed elements, the geometry of a feed element, or the spatial span of feed amplitude of feed phase. For example, in certain embodiments, the non-uniformly spaced feed array 1210 or the non-uniformly spaced feed array 1310 is configured as the patch antenna array 1800. That is, in certain embodiments, the patch antenna array 1800 is configured for use in the planar lens antenna system 1200 or planar lens antenna system 1300.

In certain embodiments, the patch antenna array 1800 includes a number of sub-group patch elements 1805a-n. The sub-group patch elements 1805a-n can be the same as, or similar to, the sub-group patch elements 1310 in FIG. 13. That is, the sub-group patch elements 1805a-n can be configured for use in the planar lens antenna system 1200 or planar lens antenna system 1300. The number of feed elements is not fixed. Further, the patch elements in each sub-group patch 1805 is fed by the same, namely a single, respective source such that the first sub-group patch 1805a is fed by a first source, the second sub-group patch 1805b is fed by a second source and so forth. For example, a first sub-group patch element 1805a (“Group 1”) can include three patch elements 1810; a second sub-group patch element 1805b (“Group 2”) can include two patch elements 1815; and an n^{th} sub-group patch element 1805a (“Group N”) can include one patch element 1820. Additionally, the patch antenna array 1800 can include a number of individual patch elements 1825 as well as the sub-group patch elements 1805a-n. In the example shown in FIG. 18, the patch antenna array 1800 includes three sub-group patch elements. However, the patch antenna array 1800 can include more are less sub-group patch elements without departing from the scope of the present disclosure. Additionally, although the sub-group patch elements 1805a-n include three, two and one patch elements respectively, one or more sub-group patch elements can include more than three patch elements.

In certain embodiments, the geometry of a patch (feed) element is not fixed. The geometry of each patch element can be a square, a circle, bow-tie, or any suitable geometric shape. For example, the patch elements 1810 in the first sub-group patch element 1805a can be dimensioned to be square; the patch elements 1815 in the second sub-group patch element 1805b can be dimensioned to be circular; and the patch elements 1820 in the n^{th} sub-group patch element 1805n can be dimensioned to be in a bow-tie shape. In certain embodiments, each sub-group patch element 1805a-n includes different geometric shaped patch elements. In certain embodiments, one or more sub-group patch elements 1805. Additionally, one or more of the individual, namely ungrouped, patch elements 1825 can be dimensioned to be a square, a circle, bow-tie, or any suitable geometric shape.

In certain embodiments, the feed amplitude 1830 or feed phase 1835, or both, of each group of feed elements is different, namely S1≠S2≠ . . . ≠SN. The excitation amplitude or phase, or both, within each group of feed elements can be different among the feed elements.

FIG. 19 illustrates an example of a patch antenna array with uniformly spaced patch elements according to this disclosure. FIG. 20 illustrates a patch antenna array with non-uniformly spaced patch elements according to this disclosure. The embodiments of the patch antenna array 1900 and of the patch antenna array 2000 shown in FIGS. 19 and 20 are for illustration only. Other embodiments could be used without departing from the scope of the present disclosure.

The 1×7 patch array 1005 in the planar lens antenna system 1000 can be configured the same as, or similar to, the patch antenna array 1900. The of the patch antenna array 1900 includes a number of patch elements 1905 uniformly spaced apart from each other such that a first spacing (S₁) 1910 between two adjacent patch elements 1905 is equal to a second spacing (S₂) 1915 between another two adjacent patch elements, which is also equal to an N^{th} spacing (S_{N}) 1920 between yet another two adjacent patch elements. That is, S₁=S₂=S_{N}.

In contrast to the patch antenna array 1900, the planar lens antenna system 1200 or planar lens antenna system 1300 can include a patch array configured as the patch antenna array 2000 in FIG. 20. The of the patch antenna array 2000 includes a number of patch elements 2005 non-uniformly spaced apart from each other such that a first spacing (S₁) 2010 between two adjacent patch elements 2005 is not equal to a second spacing (S₂) 2015 between another two adjacent patch elements; both of which are also not equal to an N^{th} spacing (S_{N}) 2020 between yet another two adjacent patch elements. That is, S₁≠S₂≠S_{N} and S₁≠S_{N}. The geometry of each patch (feed) element 2005 can be different. That is, the geometric shape of the patch elements 2005 is not fixed and one or more patch elements 2005 can be a square, a circle, a bow-tie, and so forth. The feed amplitude, feed phase, or both, of each element can be different from the other elements and can be different from such excitation as opposed to what is usually employed for conventional phased arrays.

Linear arrays (or one-dimensional arrays) are presented above to simplify the description of the prior art and the new invention. However, the concepts presented may be extended to arrays in two dimensions without loss of generality.

In certain embodiments, for the non-uniform feed methods, the planar lens 900 can be one of a number of different types of lenses, such as conformal dielectric, hybrid and Fresnel lenses fed by flat feed plane. In certain embodiments, the patch elements comprise a square-shape λ/2 patch element for each feed element. In certain embodiments, non-uniform excitation or spacing is applied for combination of diverse-shape and type feed elements. The shape of the patch elements can be rectangular, elliptical, triangular, and so forth. In certain embodiments, the feed antenna can be of any type of feed such as patch, dipole, slot, horn, and so forth. While presented novelties focus on gain enhancement, the non-uniform feed method can be extended for other beam shaping purpose such as beam broadening. The planar lens antenna systems in embodiments of the present disclosure can be fabricated and integrated with various platforms without the strict requirement for the fabrication process such as PCB and CMOS process. In certain embodiments, the planar lens antenna systems in embodiments of the present disclosure include lenses with combinations of non-uniformly grouped switched sub-array feed and non-uniformly spaced feed arrays.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus comprising:
a planar lens comprising a plurality of layers of conductive elements and a substrate layer; and
an antenna array comprising a plurality of non-uniformly spaced feed elements, wherein a first spacing (S1) between a first patch element and a second patch element adjacent to the first patch element is not equal to a second spacing (S2) between the second patch element and a third patch element adjacent to the second patch element.

2. The apparatus of claim 1, wherein the patch elements comprise a geometric shape of at least one of: a square, a circle, and a bow-tie configuration.

3. The apparatus of claim 1, wherein the patch elements comprise a type of at least one of: a patch, a dipole, a slot and a horn antenna.

4. The apparatus of claim 1, wherein one or more of the patch elements are grouped to form a sub-group patch element, wherein the elements within a sub-group patch element receive a same feed from a same source.

5. The apparatus of claim 4, wherein a first spacing between a first feed connected to a first sub-group and a second feed connected to a second sub-group adjacent to the first feed is not equal to a second spacing between the second feed and a third feed connected to a third sub-group adjacent to the second feed.

6. The apparatus of claim 4, wherein the first sub-group patch element comprises a different number of patch elements than the second sub-group patch element.

7. A method comprising:
transmitting electromagnetic waves through a planar lens antenna system comprising a planar lens and an antenna array comprising a plurality of non-uniformly spaced feed elements, wherein a first spacing (S1) between a first patch element and a second patch element adjacent to the first patch element is not equal to a second spacing (S2) between the second patch element and a third patch element adjacent to the second patch element.

8. The method of claim 7, wherein the patch elements comprise a geometric shape of at least one of: a square, a circle, and a bow-tie configuration.

9. The method of claim 7, wherein the patch elements comprise a type of at least one of: a patch, a dipole, a slot and a horn antenna.

10. The method of claim 7, wherein one or more of the patch elements are grouped to form a sub-group patch element, wherein the elements within a sub-group patch element receive a same feed from a same source.

11. The method of claim 10, wherein a first spacing between a first feed connected to a first sub-group and a second feed connected to a second sub-group adjacent to the first feed is not equal to a second spacing between the second feed and a third feed connected to a third sub-group adjacent to the second feed.

12. The method of claim 10, wherein the first sub-group patch element comprises a different number of patch elements than the second sub-group patch element.

13. The method of claim 10, wherein transmitting comprises providing a non-uniform voltage amplitude such that a feed amplitude for the first sub-group patch element is different than a feed amplitude for the second sub-group patch element.

14. The method of claim 10, wherein transmitting comprises providing a non-uniform power phase such that a feed phase for the first sub-group patch element is different than a feed phase for the second sub-group patch element

15. A system comprising:
a planar lens array antenna system comprising:
a planar lens comprising a plurality of layers of conductive elements and a substrate layer; and
an antenna array comprising a plurality of non-uniformly spaced feed elements, wherein a first spacing (S1) between a first patch element and a second patch element adjacent to the first patch element is not equal to a second spacing (S2) between the second patch element and a third patch element adjacent to the second patch element; and
a transmitter or transceiver configured to generate signals for wireless transmission or receive signals transmitted wirelessly via the planar lens array antenna system.

16. The system of claim 15, wherein the patch elements comprise a geometric shape of at least one of: a square, a circle, and a bow-tie configuration.

17. The system of claim 15, wherein the patch elements comprise a type of at least one of: a patch, a dipole, a slot and a horn antenna.

18. The system of claim 15, wherein one or more of the patch elements are grouped to form a sub-group patch element, wherein the elements within a sub-group patch element receive a same feed from a same source.

19. The system of claim 18, wherein a first spacing between a first feed connected to a first sub-group and a second feed connected to a second sub-group adjacent to the first feed is not equal to a second spacing between the second feed and a third feed connected to a third sub-group adjacent to the second feed.

20. The system of claim 18, wherein the first sub-group patch element comprises a different number of patch elements than the second sub-group patch element.
